(19) United States
(12) Patent Application Publication
(10) Pub. No.: US 2018/0281346 A1
(43) Pub. Date: Oct. 4, 2018

(54) REINFORCEMENT TAPE AND AN ASSEMBLY OF THE REINFORCEMENT TAPE AND A SUBSTRATE

(71) Applicant: JOE GREEN PTE. LTD., Singapore (SG)

(72) Inventor: Boediman WIDJAJA, Singapore (SG)

(73) Assignee: JOE GREEN PTE. LTD., Singapore (SG)

(21) Appl. No.: 15/474,590

(22) Filed: Mar. 30, 2017

(51) Int. Cl. B32B 7/14; B32B 27/30; B32B 38/00

(52) U.S. Cl. CPC B32B 7/14; B32B 27/304; B32B 2310/0831; B32B 2405/00; B32B 2327/06; B32B 38/0008

(57) ABSTRACT

The present invention provides a reinforcement tape, the reinforcement tape comprising a plurality of perforations around at least one edge of two opposite edges along a length of the reinforcement tape and a substantially solid portion in between the two opposite edges. Another embodiment of the present invention provides an assembly of a substrate and a reinforcement tape for reinforcement of said substrate. The assembly comprising a layer of a first bonding material applied at said substrate; a reinforcement tape applied at said layer of said first bonding material, said reinforcement tape comprising a plurality of perforations around at least one edge of two opposite edges along a length of said reinforcement tape and a substantially solid portion in between said two opposite edges; and a layer of a second bonding material applied at said reinforcement tape.

### FIELD OF INVENTION

The present invention relates generally to reinforcement of substrates and more specifically to a reinforcement tape and an assembly of the reinforcement tape and a substrate.

### BACKGROUND ART

Panels of a great variety of materials, such as wood, polymers, metals and concrete can be joined to create walls and other structures. The real advantage of using the panels is that the structures can be created in a very short duration of time. Further, material can be removed at various locations in the panels, without comprising strength of the structure. This makes the structure both strong and the lightweight.

However, even though a wide variety of joint types may be used for different applications and material type, the structure still remains weakest at the joints. Moreover, the joints are also prone to degradation due to water seepage into the joints. Another, area of concern is the edges and corners of the panels. Due to presence of sharp corners around the edges, the edges are potential sites for localized stress concentration and initiation of cracks. The cracks may then propagate to the entire panel causing rupture of the panel.

Conventionally, wire meshes made up of metal or fibre material have been used to reinforce the joints between the panels. FIG. 1.0 illustrates an assembly of a plurality of panels in accordance with a prior art 100. As, can be seen from FIG. 1.0, a plurality of tongue and groove joints 130 resulting due to assembly of the plurality of panels 110 have been reinforced using a plurality of wire meshes 120.

However, the wire meshes are generally low in strength due to which they easily deform or break apart. Further, due to their inherent construction, the wire meshes are incapable of preventing seepage of water into the joints. Accordingly, there is a need in the art for improved reinforcement for panels which do not suffer from above mentioned deficiencies.

### SUMMARY OF INVENTION

The present invention relates to reinforcement of substrates and more specifically to a reinforcement tape and an assembly of the reinforcement tape and a substrate.

According to a first aspect of the present invention, there is provided a reinforcement tape, comprising a plurality of perforations around at least one edge of two opposite edges along a length of the reinforcement tape and a substantially solid portion in between the two opposite edges. The plurality of perforations allows penetration of bonding materials and the substantially solid portion provides strength and resistance to water seepage.

In accordance with an embodiment of the present invention, the reinforcement tape is treated for protection from UV radiation. Treatment for UV protection allows the reinforcement tape to be used outdoors with a confidence that the reinforcement tape will last for a fair amount of time.

In accordance with an embodiment of the present invention, the reinforcement tape is made up of a polymer material. Polymer materials have high strength to weight ratios and ability to expand up to double their lengths. Also, polymer materials are cheap and easily mouldable.

In accordance with an embodiment of the present invention, the polymer material is Poly Vinyl Chloride (PVC). PVC is known to be strong, light and easily available.

According to a second aspect of the present invention, there is provided an assembly of a substrate and a reinforcement tape for reinforcement of the substrate, the assembly comprising a layer of a first bonding material applied at the substrate, a reinforcement tape applied at the layer of the first bonding material, the reinforcement tape comprising a plurality of perforations around at least one edge of two opposite edges along a length of the reinforcement tape and a substantially solid portion in between the two opposite edges and a layer of a second bonding material applied at the reinforcement tape. Further, the first bonding material and the second bonding material are adapted to penetrate through the plurality of perforations in order to bind the reinforcement tape to the substrate.

In accordance with an embodiment of the present invention, the first bonding material and the second bonding material are selected from a group consisting of an adhesive, cement grout or a combination thereof. The adhesive and cement grout combinations are readily available in market, hence this makes the invention fairly easy to implement.

In accordance with an embodiment of the present invention, the substrate is at least one of a joint between two panels, an inner corner edge and an outer corner edge.

In case of the substrate being the joint, in addition to providing reinforcement, the substantially solid portion also provides resistance against water seepage in to the joint. Also, the reinforcement tape will deter initiation or propagation of a crack such as a hairline crack. In case of the substrate being the inner corner edge or, the reinforcement tape will act as a corner bead to control verticality of the panel to which the reinforcement tape has been applied.

In accordance with an embodiment of the present invention, the joint is a tongue and groove joint. However, in other embodiment, any kind of joints may be used.

In accordance with an embodiment of the present invention, the two panels are made of a coagulable material. Hence the panels may be installed at any time at a site of construction.

In accordance with an embodiment of the present invention, the coagulable material is cement. Hollow Core Concrete is lightweight and a strong construction material.

According to a third aspect of the present invention, there is provided a method of manufacturing a reinforcement tape, the method comprising a step of providing a plurality of perforations around at least one edge of two opposite edges along a length of the reinforcement tape such that a substantially solid portion is provided in between the two opposite edges.

In accordance with an embodiment of the present invention, the method further comprises a step of treating the reinforcement tape for protection of the reinforcement tape from UV radiation.

According to a fourth aspect of the present invention, there is provided a method of assembling a substrate and a reinforcement tape for reinforcement of the substrate, the method comprising steps of applying a layer of a first bonding material at the substrate, applying a reinforcement tape at the layer of the first bonding material, the reinforcement tape comprising a plurality of perforations around at least one edge of two opposite edges along a length of the reinforcement tape and a substantially solid portion in between the two opposite edges and applying a layer of a second bonding material at the reinforcement tape. Further, the first bonding material and the second bonding material penetrate through the plurality of perforations in order to bind the reinforcement tape to the substrate.

The present invention includes features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates an assembly of panels in accordance with a prior art.

FIG. 2a and FIG. 2b illustrate a reinforcement tape in accordance with an embodiment of the present invention.

FIG. 3 illustrates a sectional view of an assembly of the reinforcement tape and a substrate, for reinforcement of the substrate, in accordance with an embodiment of the present invention.

FIG. 4 illustrates a method for assembling the reinforcement tape and the substrate, for reinforcement of the substrate, in accordance with an embodiment of the present invention.

FIG. 5 illustrates a series of visual steps of a method for assembling the reinforcement tape and the substrate, in accordance an exemplary embodiment of the present invention.

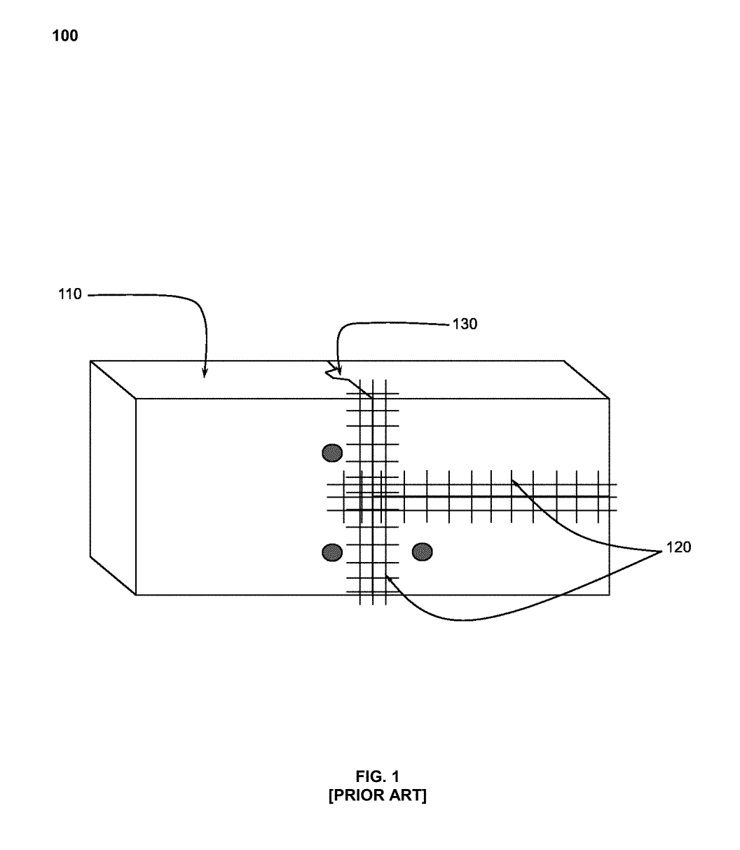

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

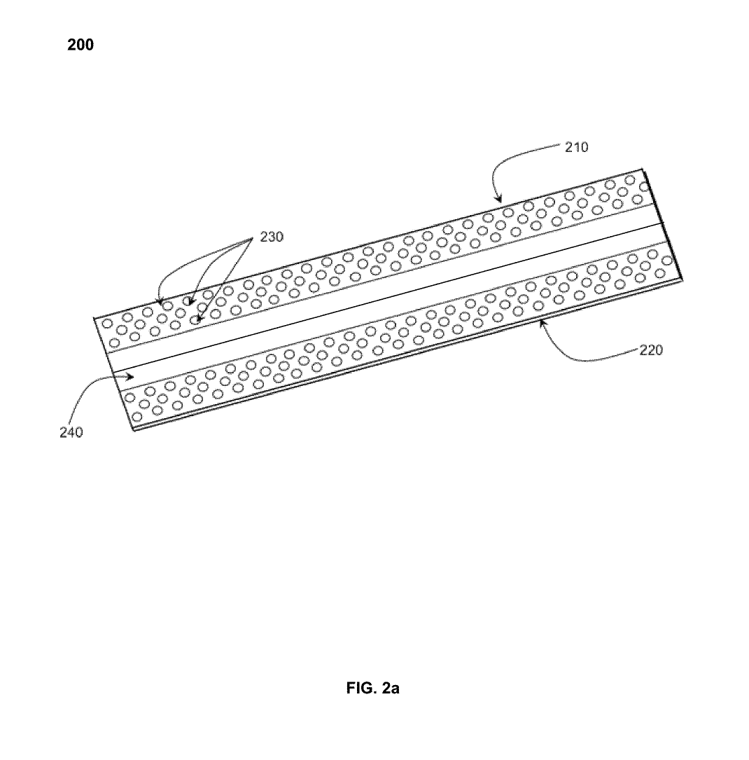

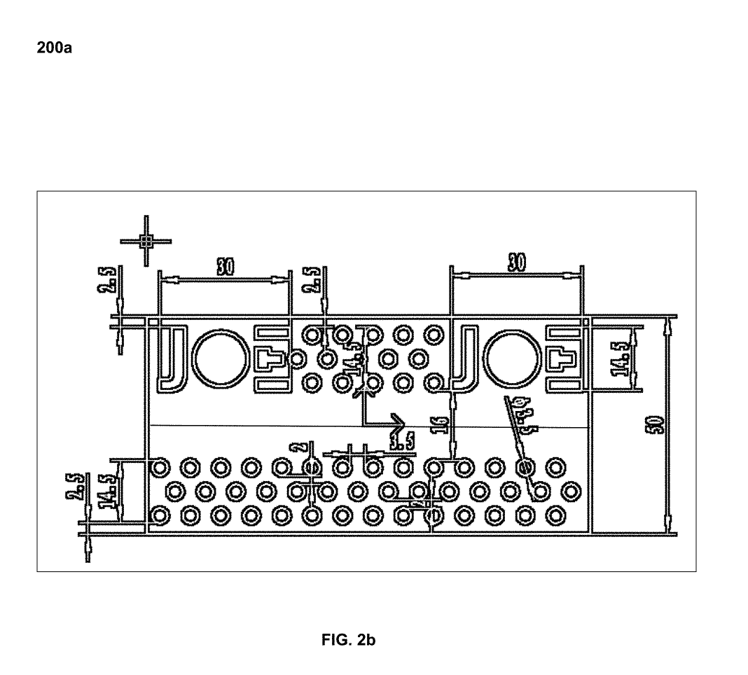

Referring to the drawings, the invention will now be described in more detail. FIG. 2a and FIG. 2b illustrate a reinforcement tape (200 and 200a) in accordance with an embodiment of the present invention. As shown in FIG. 2a, the reinforcement tape (200) comprises a plurality of perforations (230). Further, the plurality of perforations (230) are provided around at least one edge of two opposite edges (210 and 220) along a length of a reinforcement tape (200). In accordance with an embodiment, the pluralities of perforations (230) are provided in a staggered pattern, as shown in FIG. 2a. Further, the reinforcement tape (200) comprises a substantially solid portion (240) in between the two opposite edges (210 and 220).

In accordance with an embodiment, the reinforcement tape (200) has been treated for Ultra-Violet (UV) protection. Treating the reinforcement tape (200) for UV protection allows the reinforcement tape (200) to survive for longer durations of time, especially when the reinforcement tape (200) has been used outdoors or is directly exposed to sun. In accordance with an embodiment of the present invention, the reinforcement tape (200) is made up of polymer material. The polymer materials are known to have fairly high tensile strengths and capability to elongate up to lengths of even two hundred percent of their original length. Further, in accordance with an embodiment, the polymer material is, but not limited to, Poly Vinyl Chloride (PVC). PVC is known to be strong and lightweight.

In accordance with an embodiment, the reinforcement tape (200) is manufactured by providing the plurality of perforations (230) around at least one edge of two opposite edges (210 and 220) along a length of the reinforcement tape (200) such that the substantially solid portion (240) is provided in between the two opposite edges (210 and 220). Further, in accordance with an embodiment, the reinforcement tape (200) is treated for UV protection. The reinforcement tape (200) may be used to assemble it with a substrate for reinforcing the substrate.

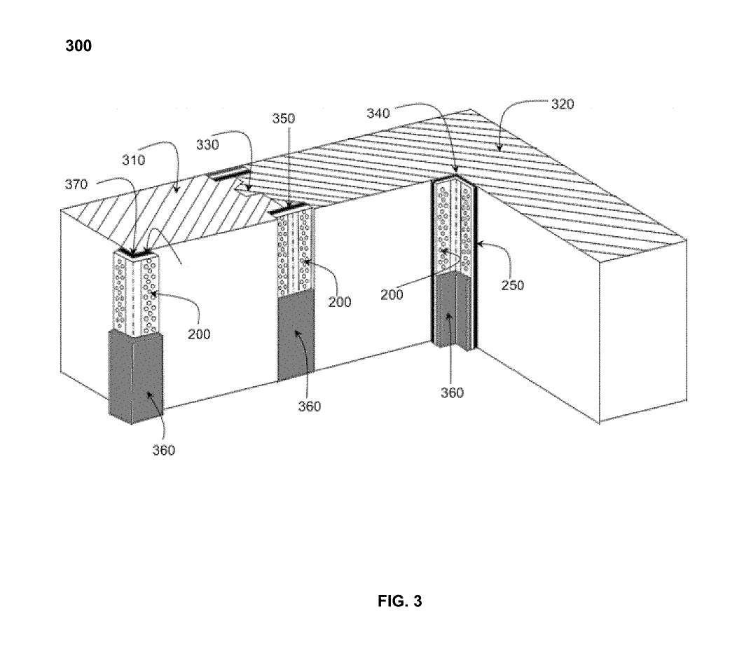

FIG. 3 illustrates a sectional view of an assembly (300) of the reinforcement tape (200) and a substrate, for reinforcement of the substrate, in accordance with an embodiment of the present invention. The assembly (300) comprises a layer of first bonding material (350) applied at the substrate. Further, the assembly (300) comprises the reinforcement tape (200) applied at the layer of the first bonding material (350). Further, the assembly (300) comprises a layer of the second bonding material (360) applied at the reinforcement tape (200). It is to be noted here that the layer of the second bonding material (360) has been shown to have been applied partially only for clarity of FIG. 3.

However, in a real world application, the layer of the second bonding material (360) may also be applied to totally cover the reinforcement tape (200). Preferably, a minimum overlap of about 50 mm may be desired between the layer of first bonding material (350) and the layer of second bonding material (360).

Further, the first bonding material (350) and the second bonding material (360) are adapted to penetrate through the plurality of perforations (230) in order to bind the reinforcement tape (200) to the substrate. In accordance with an embodiment of the present invention, the first bonding material (350) and the second bonding material (360) are selected from a group consisting of an adhesive, cement grout or a combination thereof. Preferably, if the substrate is made up of concrete, the first bonding material (350) is an adhesive and the second bonding material (360) is a combination of the adhesive and the cement grout.

In accordance with an embodiment of the present invention, the substrate is at least one of a joint (330) between two panels (310 and 320), an inner corner edge (340) of a panel (320) and an outer corner edge (370) of another panel (310). In case of the substrate being the joint (330), in addition to providing reinforcement, the substantially solid portion (240) also provides resistance against water seepage in to the joint (330). In accordance with an embodiment, the joint (330) is a tongue and groove joint. However, the invention is not limited to tongue and groove joints only, but the invention can also be applied to other joints such as a butt joint.

Also, the reinforcement tape (200) will deter initiation or propagation of a crack such as a hairline crack. In case of the substrate being the inner corner edge (340) or the outer corner edge (370), the reinforcement tape (200) will act as a corner bead to control verticality of the panel (320) or the other panel (310), respectively. It will be appreciated by a person skilled in the art, that the substrate may be inner and/or outer corner edge of any of the panel (320), the other panel (310) or any other panel being used during construction of a structure and not necessarily being a part of any joint.

In accordance with an embodiment, the two panels (310 and 320) are made of a coagulable material. Hence the two panels (310 and 320) may be install readily on a site of construction. Further, in accordance with an embodiment, the coagulable material is cement or concrete. Hollow core concrete is lightweight and a strong construction material. Cement is strong, lightweight and cheap, thus the two panels (310 and 320) may be made inexpensively and to last for a fairly long duration. It is to be noted here that other variations of concrete or cement panels, such as Autoclaved Aerated Concrete (ALC), Magnesium Oxide Wallboard (MGO) may also be used. Further, the invention is not limited to concrete panels alone, rather the invention, and particularly the reinforcement tape (200), may be used with panels of other materials such as, but not limited to, wood, polymers, metals and fibre with suitable bonding material combinations.

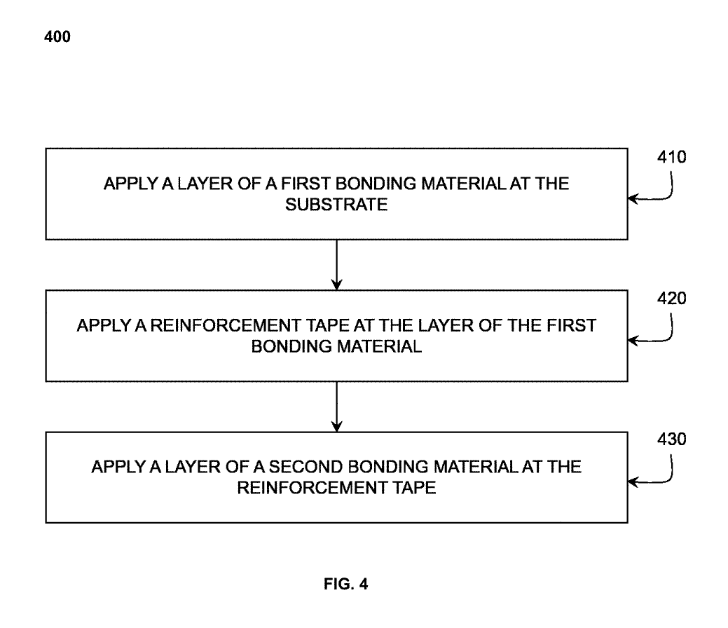

FIG. 4 illustrates a method (400) for assembling the substrate and the reinforcement tape (200), for reinforcement of the substrate, in accordance with an embodiment of the present invention. The method begins at step 410 by applying the layer of the first bonding material (350) at the substrate. At step 420, the reinforcement tape (200) is applied at the layer of the first bonding material (350). At step 430, the layer of the second bonding material (360) is applied at the reinforcement tape (200). Also, the first bonding material (350) and the second bonding material (360) penetrate through the plurality of perforations (230) in order to bind the reinforcement tape (200) to the substrate.

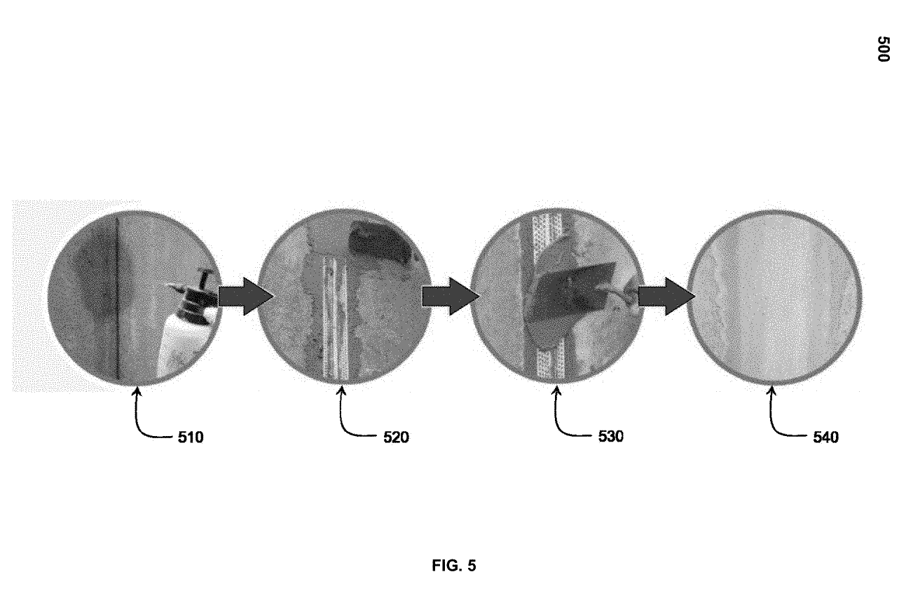

FIG. 5 illustrates a series of visual steps of a method for assembling the reinforcement tape and the substrate, in accordance an exemplary embodiment (500) of the present invention. As shown in FIG. 5, at step 510, a thin layer of an adhesive and cement grout combination (typically 3 mm) is applied at the substrate, after making the substrate moist by spraying water. Further, the reinforcement tape (200) is applied over the layer of the adhesive and the cement grout combination. At step 520, the reinforcement tape (200) is pressed to allow the adhesive and the cement grout combination to penetrate through the plurality of perforations (230) for better bonding and grip. At step 530, excessive adhesive and cement grout combination is removed from the reinforcement tape (200) and another thin layer of the adhesive and the cement grout combination (2-3 mm typically) is applied over the reinforcement tape (200). The other thin layer of the adhesive and cement grout combination is levelled to finish. At step 540, the assembly is allowed to cure and sanded lightly if required.

The present invention provides a reinforcement tape to facilitate a highly flexible centred joint of high restraint, tensile strength of about 2-4 times higher than cement mortar and elongation property of 200+%. Further, the invention can bridge crack of up to 2 mm and increase water seepage resistance when compared to metal wire or fibre mesh with open gauges. The invention can also double up and used as inner, outer corner bead for easy rendering to control verticality. Further, the invention can be applied to perimeter joints as reinforcement to other building structure connections for strengthening and prevention of cracks.

Modifications to these embodiments are apparent to those skilled in the art from the description and accompanying drawings. The principles associated with the various embodiments described herein may be applied to other embodiments. Therefore, the description is not intended to be limited to the embodiments shown with the accompanying drawings but is to be given broadest scope consistent with the principles and the novel and inventive features disclosed or suggested herein. Accordingly, the invention is anticipated to extend to all other such alternatives, modifications, and variations that fall within the scope of the present invention and appended claim.

1. A reinforcement tape, said reinforcement tape comprising:
a plurality of perforations around at least one edge of two opposite edges along a length of said reinforcement tape, a substantially flat, solid portion between the plurality of perforations; and
a substantially solid portion in between said two opposite edges.

2. The reinforcement tape as claimed in claim 1, wherein said reinforcement tape is treated for protection from UV radiation.

3. The reinforcement tape as claimed in claim 1, wherein said reinforcement tape is made up of a polymer material.

4. The reinforcement tape as claimed in claim 3, wherein said polymer material is Poly Vinyl Chloride (PVC).

5. An assembly of a substrate and a reinforcement tape for reinforcement of said substrate, said assembly comprising:
a layer of a first bonding material applied at said substrate;
a reinforcement tape applied at said layer of said first bonding material, said reinforcement tape comprising a plurality of perforations around at least one edge of two opposite edges along a length of said reinforcement tape, a substantially flat, solid portion between the plurality of perforations and a substantially solid portion in between said two opposite edges; and
a layer of a second bonding material applied at said reinforcement tape;
wherein said first bonding material and said second bonding material are adapted to penetrate through said plurality of perforations in order to bind said reinforcement tape to said substrate.

6. The assembly as claimed in claim 5, wherein said reinforcement tape is treated for protection of said reinforcement tape from UV radiation.

7. The assembly as claimed in claim 5, wherein said reinforcement tape is made up of a polymer material.

8. The assembly as claimed in claim 7, wherein said polymer material is Poly Vinyl Chloride (PVC).

9. The assembly as claimed in claim 5, wherein said first bonding material and said second bonding material are selected from a group consisting of an adhesive, cement grout or a combination thereof.

10. The assembly as claimed in claim 5, wherein said substrate is at least one of a joint between two panels, an inner corner edge and an outer corner edge.

11. The assembly as claimed in claim 10, wherein said joint is a tongue and groove joint.

12. The assembly as claimed in claim 10, wherein said two panels are made of a coagulable material.

13. The assembly as claimed in claim 12, wherein said coagulable material is cement.

14. A method of manufacturing a reinforcement tape, said method comprising steps of:
providing a plurality of perforations around at least one edge of two opposite edges along a length of said reinforcement tape, wherein the length of said reinforcement tape is substantially flat and solid between the plurality of perforations, and such that a substantially solid portion is provided in between said two opposite edges.

15. The method as claimed in claim 14, further comprises a step of treating said reinforcement tape for protection of said reinforcement tape from UV radiation.

16. A method of assembling a substrate and a reinforcement tape for reinforcement of said substrate, said method comprising steps of:
applying a layer of a first bonding material at said substrate;
applying a reinforcement tape at said layer of said first bonding material, said reinforcement tape comprising a plurality of perforations around at least one edge of two opposite edges along a length of said reinforcement tape, wherein the length of said reinforcement tape is substantially flat and solid between the plurality of perforations, and a substantially solid portion in between said two opposite edges; and
applying a layer of a second bonding material at said reinforcement tape;
wherein said first bonding material and said second bonding material penetrate through said plurality of perforations in order to bind said reinforcement tape to said substrate.
